(19) United States
(12) Patent Application Publication
(10) Pub. No.: US 2025/0041893 A1
(43) Pub. Date: Feb. 6, 2025

(54) TREATMENT SYSTEM AND METHOD FOR TREATING WORKPIECES

(71) Applicant: DÜRR SYSTEMS AG, Bietigheim-Bissingen (DE)

(72) Inventors: Tobias JÄGER, Karlsruhe (DE); Oliver SEYBOTH, Hemmingen (DE)

(21) Appl. No.: 18/720,439

(22) PCT Filed: Dec. 21, 2022
(86) PCT No.: PCT/DE2022/100972

§ 371 Date: Jun. 14, 2024

(30) Foreign Application Priority Data
Dec. 23, 2021 (DE) 10 2021 214 987.1

(51) Int. Cl. B05C 3/109; B05C 11/10; B08B 3/14; B08B 13/00

(52) U.S. Cl. CPC B05C 3/109; B05C 11/1002; B05C 11/1039; B08B 3/14; B08B 13/00

(57) ABSTRACT

In order to provide a treatment system for treating workpieces, in particular for cleaning and/or coating vehicle bodies, said system being simply constructed and efficiently usable, it is proposed that the treatment system comprises the following: a) multiple treatment stations, each of which comprises a treatment container that surrounds a treatment chamber for receiving the workpieces; b) one or more fluid tanks for receiving a fluid; and c) a fluid guide, by means of which the fluid can be guided i) from the one or more fluid tanks into at least one of the treatment chambers in order to flood the at least one treatment chamber and/or ii) from the at least one treatment chamber into the one or more fluid tanks in order to empty the at least one treatment chamber.

### RELATED APPLICATIONS

This application is a national phase of international application No. PCT/DE2022/100972 filed on Dec. 21, 2022, and claims the benefit of German application No. 10 2021 214 987.1 filed on Dec. 23, 2021, which are incorporated herein by reference in their entirety and for all purposes.

### FIELD OF DISCLOSURE

The present disclosure relates to the field of workpiece treatment, and in particular cleaning and coating workpieces-for example, vehicle bodies or vehicle parts.

### BACKGROUND

For the treatment of workpieces, the latter can be dipped into dip tanks, for example. In this case, the workpieces are lowered into a dip tank, for example, and are removed from the dip tank after a treatment step. In doing so, a rotation of the workpiece for optimal treatment of the same even at locations that are difficult to access may also be provided.

In such dip treatment systems, it may be disadvantageous if workpieces of different sizes and/or shapes are to be treated and/or if different treatment durations are provided for various workpieces.

### SUMMARY

The object of examples disclosed herein is therefore to provide a device and a method which allow optimized workpiece treatment using cost-efficient components.

This object is achieved by the treatment system and by the method according to the independent claims.

The treatment system serves to treat workpieces and comprises in particular one or more treatment stations for performing one or more treatment steps in each case.

A treatment station preferably comprises a treatment container which surrounds a treatment chamber for receiving the workpieces.

Furthermore, it can be provided that a treatment station comprises a plurality of such treatment containers.

It is preferably provided that the treatment chamber be able to be flooded with a fluid.

The fluid is in particular a treatment fluid, e.g., a cleaning fluid-in particular, for degreasing the workpieces. Furthermore, it can be provided that the fluid be a coating fluid-for example, for phosphating or painting the workpieces.

During its entire use for workpiece treatment, the fluid is preferably in the liquid aggregation state. In particular, the fluid is liquid under normal conditions.

It can be provided that the treatment container comprises at least one access opening for introducing the workpieces into the treatment chamber and/or for removing the workpieces from the treatment chamber.

The treatment container preferably comprises a closing device for selectively closing and opening the at least one access opening.

It can be provided that the treatment container comprises a single access opening for introducing the workpieces into the treatment chamber and for removing the workpieces from the treatment chamber.

Alternatively, it can be provided that the treatment container comprises an access opening for introducing the workpieces into the treatment chamber and a further access opening for removing the workpieces from the treatment chamber, wherein the access openings are then arranged in particular on opposite sides or ends or end walls of the treatment container.

It can be advantageous if at least one access opening is arranged and/or formed in one or more side walls of the treatment container-in particular, in one or more end walls of the treatment container.

The treatment container is in particular substantially cuboid and preferably comprises a ceiling wall which is, for example, closed, a bottom wall, two or three closed side walls, and two further and/or one further side wall, which is provided with at least one access opening, wherein the at least one access opening is preferably completely closable by means of the closure device.

It can be advantageous if the closing device is used for fluid-tight closing of the at least one access opening.

For this purpose, the closing device comprises in particular a closing element which, for example, is self-locking and/or is provided with a self-locking mechanism and/or with a self-locking seal. It can be advantageous if the closing device comprises a lifting device for raising and lowering a closing element of the closing device-in particular, for raising the closing element in order to bring it into an open position, and/or for lowering the closing element in order to bring it into a closed position. Furthermore, it can be provided that the closing element be able to be lowered by means of the lifting device in order to bring it into an open position, and/or be able to be lifted in order to bring it into a closed position. Such a closing element can, for example, be a gate-in particular, a floodgate.

The closing element may, for example, be formed in one piece and may be movable as a whole. Alternatively thereto, it can be provided that the closing element be designed in multiple parts, wherein the parts of the closing element can preferably be moved independently of one another or execute different movements from one another in order to close or open the access opening.

Alternatively or additionally, it can be provided that the closing device comprises a sliding device for, for example, lateral displacement of the closing element in order to optionally bring it into an open position or into a closed position.

Furthermore, it can be provided that the closing device comprises a pivoting device for pivoting a closing element of the closing device, wherein the closing element is in particular pivotable about an at least approximately horizontal pivot axis. Alternatively thereto, it can be provided that the closing element be pivotable about an at least approximately vertical pivot axis.

It can be advantageous if the treatment station comprises a fluid tank for receiving a fluid—in particular, a treatment fluid.

For flooding the treatment chamber, the fluid can preferably be introduced from the fluid tank into the treatment chamber by means of a fluid guide.

For emptying the treatment chamber, the fluid can preferably be guided from the treatment chamber back into the fluid tank by means of the fluid guide.

A direct connection between the treatment chamber and the fluid tank may be provided both for flooding and for emptying. Alternatively, one or more intermediate stations or other devices to be flowed through may be provided.

The treatment station preferably comprises a conveying device for conveying the workpieces—in particular, for introducing the workpieces into the treatment chamber, and/or for removing the workpieces from the treatment chamber, and/or for conveying the workpieces from one treatment station to the next.

It can be advantageous if the conveyor device comprises one or more roller conveyors, lifting conveyors, sliding conveyors, and/or stacker cranes for conveying and/or moving the workpieces—in particular, for bringing the workpieces into the treatment room and/or for removing the workpieces from the treatment room and/or for conveying the workpieces from one treatment station to the next.

Alternatively or additionally, it can be provided that the conveying device comprises one or more driverless transport systems for conveying and/or moving the workpieces—in particular, for introducing the workpieces into the treatment chamber, and/or for removing the workpieces from the treatment chamber, and/or for conveying the workpieces from one treatment station to the next.

The workpieces can preferably be moved, in particular introduced into the treatment chamber and/or discharged from the treatment chamber, along a horizontal plane by means of the conveyor device.

A method for treating workpieces can in particular be performed by means of the treatment station. Preferably, the method comprises the following steps: Introducing a workpiece through an access opening of a treatment container into a treatment chamber of the treatment container;

Closing the access opening of the treatment container by means of a closing device; Flooding the treatment chamber with a fluid for performing a workpiece treatment.

After the workpiece treatment (treatment step) has been performed, the fluid is preferably removed, in particular drained, from the treatment chamber.

Furthermore, the workpiece is then preferably removed from the treatment chamber through the one access opening or a further access opening.

In an advantageous embodiment of examples disclosed herein, it can be provided that the treatment station comprises a fluid tank for receiving a fluid. Furthermore, the treatment station preferably comprises a fluid guide by means of which the fluid can be guided from the fluid tank into the treatment container in order to flood the treatment chamber, and/or from the treatment container into the fluid tank in order to empty the treatment chamber.

For this purpose, the fluid guide preferably comprises one or more fluid lines, wherein preferably a fluid line for supplying the fluid from the fluid tank to the treatment container and a further fluid line, in particular a separate fluid line, for supplying the fluid from the treatment container to the fluid tank are provided.

It may be favorable if the fluid tank is arranged above the treatment container with respect to the direction of gravity.

As a result, gravity can in particular be used for feeding the fluid to the treatment container, wherein a separate pump device can preferably be unnecessary.

In contrast, a pump device may be advantageous in order to pump the fluid from the treatment chamber back into the fluid tank.

Alternatively, it can be provided that the treatment container is arranged above the fluid tank with respect to the direction of gravity. As a result, the fluid can then be guided from the treatment container into the fluid tank without using a pump device, while a pump device is preferably provided in order to guide the fluid from the fluid tank into the treatment container.

It can be provided that the fluid guide comprises a fluid line designed as a supply line, by means of which the fluid can be supplied to the treatment chamber, wherein the supply line preferably opens into the treatment chamber in a bottom region of the treatment container. In particular, undesired foam formation during the supplying of the fluid into the treatment container can thereby be reduced or completely avoided.

A bottom region of the treatment container is in particular a lower third, preferably a lower fifth, of the treatment chamber with respect to the total height of the treatment chamber and/or with respect to a maximum filling height.

The treatment container preferably comprises an inflow region which is arranged in particular below an access opening of the treatment container. The inflow region is preferably also filled with fluid in an emptied state of the treatment container provided for replacing a workpiece.

The supply line preferably opens into the inflow region, in particular below a fluid line of the inflow region, to allow fluid to be supplied into the treatment chamber in an optimized manner.

It can be advantageous if the fluid guide comprises a plurality of supply lines, wherein one or more of these supply lines open into the treatment container in a bottom region thereof, and/or wherein one or more supply lines end in or on one or more nozzles or other supply openings, by means of which the fluid can be directed and/or applied to the workpieces, for example as a jet or stream.

An emptied state of the treatment container is preferably a state of the treatment container in which the one or more access openings can be opened without achieving or fearing fluid escaping through the access openings. An empty state thus in particular does not have to be a state of the treatment container in which all residual fluid has been removed from the treatment container.

A medium, in particular a gas, for example air, displaced from the treatment chamber during flooding thereof can, for example, be released to the surroundings or processed and/or conveyed further, for example, to an exhaust air purification system and/or into a dryer for drying the workpieces.

In particular, a pressure equalization device can be provided in order to equalize pressure variations resulting from fluid flows. In particular, the pressure equalization device can serve to prevent or at least reduce a pressure rise resulting from introduction of liquid, in particular treatment liquid, into a fluid tank, for example by draining gas displaced by means of the liquid.

Furthermore, it can be provided that the displaced medium is introduced into the fluid tank.

It may be advantageous if the fluid guide comprises a cleaning device for cleaning the fluid.

The cleaning device is preferably arranged outside the treatment container and/or outside the fluid tank.

Preferably, the cleaning device is arranged in a return line for returning the fluid into the fluid tank. As a result, the fluid can preferably be cleaned and/or processed during the return of the same and/or before each start of a cycle, in particular before a renewed flooding process in one or more treatment containers.

It can be advantageous if the treatment device comprises a heat exchanger, by means of which fluid, in particular fluid to be returned or returned fluid, in particular treatment fluid, can be temperature-controlled, in particular cooled or heated. A heat transfer can take place in particular to or from surroundings of the treatment system and/or to or from a heat transfer medium.

The treatment station preferably comprises a control device by means of which a flooding process in the treatment chamber can be controlled and/or regulated-in particular, by controlling and/or regulating a valve device for opening and closing a supply line for supplying fluid to the treatment chamber.

For controlling and/or regulating the flooding process, one or more workpiece parameters are preferably taken into account, in particular a geometry and/or size and/or position of each workpiece within the treatment chamber.

The one or more workpiece parameters are transferred to the control device in particular by a machine control and/or by means of CAD data, barcode recognition, RFID information, or other workpiece-specific data sets.

The flooding process can preferably be controlled by means of the control device in such a way that a filling speed and/or a rate of change of the fill level of the fluid in the treatment chamber during flooding is varied, in particular adapted to local stability differences of the workpieces and/or adapted to a surface of the water surface that changes along the direction of gravity.

For example, it can be provided that the flooding process can be controlled by means of the control device in such a way that a fluid level in the treatment chamber increases at least approximately constantly.

Alternatively, it can be provided that the flooding process can be controlled by means of the control device in such a way that the volume flow of the supplied fluid is increased when the fluid level passes over more stable regions of the workpieces, and that the volume flow of the supplied fluid is reduced when the fluid level of the fluid passes over less stable regions of the workpieces.

The treatment station can, for example, comprise one or more measuring devices, by means of which, for example, a volume flow of the fluid flowing into the treatment chamber, and/or a fill level or filling level within the treatment chamber, and/or a fill level or filling level in the fluid tank can be determined.

One or more measured values of the one or more measuring devices are preferably taken into account in the control and/or regulation of the flooding process.

Preferably, a maximum fill height (maximum filling level) in a flooding process is selected depending on the workpiece geometry and/or position. For example, with a workpiece designed as a vehicle body, it can be provided that the treatment chamber is always filled with fluid until the filling level is just above a roof of the vehicle body, for example at most approximately 10 cm, preferably at most approximately 5 cm, for example at most approximately 3 cm above the roof.

Furthermore, it can be provided that one or more leaks are determined by means of one or more measuring devices, for example by a fill level or filling level or volume flow monitoring by means of one or more measuring devices. Preferably, a leak-tightness of one or more closing devices can be deduced therefrom.

In one embodiment, the treatment station can have a counter tank which is in particular arranged below the treatment chamber with respect to the direction of gravity and to which the fluid to be discharged from the treatment chamber can be supplied.

In this case, the fluid can preferably be guided from the fluid tank into the treatment chamber and/or from the treatment chamber into the counter tank using only gravity.

By means of a pump device, for example, the fluid can preferably be guided from the counter tank back into the fluid tank.

The fluid tank is thus in particular a reservoir tank for providing the fluid, in particular in a state of the fluid that is ready for performing a treatment process. For this purpose, the fluid can be cleaned or processed, in particular by means of a cleaning device, in particular on the conveying path between the counter tank and the fluid tank.

It can be advantageous if the treatment station comprises two or more than two treatment chambers, in particular two or more than two treatment containers, each having a treatment chamber.

In this case, a common fluid tank for feeding the fluid to the two or more than two treatment chambers may be provided.

Alternatively, a plurality of fluid tanks can be provided, in particular for a plurality of fluids in the same treatment chamber.

For example, it can be provided that a treatment chamber of a treatment station can be flooded selectively, in particular alternately, with different fluids, in particular in order to perform different treatment steps on one or more workpieces located in the treatment chamber.

Furthermore, it can be provided for this purpose that a plurality of counter tanks is provided for the plurality of fluids.

Moreover, a common counter tank for more than two treatment chambers may be provided.

In this description and the accompanying claims, a tank is in particular a general receptacle for a fluid; for example, this can be individual containers or a plurality of containers coupled to one another.

It can be provided that the treatment station comprises a flushing device for flushing and/or cleaning the treatment chamber, wherein a flushing medium can be introduced into the treatment chamber, in particular can be sprayed in, and removed from the same, in particular can be drained, independently of the fluid, independently of the fluid tank, and/or independently of a counter tank.

The flushing device can comprise spray nozzles which are in particular arranged in the treatment chamber and/or are directed into the treatment chamber and which serve, in particular, for rinsing walls and/or a conveying device arranged in the treatment chamber.

In order to treat the workpieces, it can in particular be provided in the described treatment station that the workpieces are introduced into the treatment chamber of the treatment container, and that the treatment chamber is flooded with a fluid for performing a workpiece treatment, wherein the fluid is guided from the fluid tank into the treatment container in order to flood the treatment chamber, and/or from the treatment container into the fluid tank in order to empty the treatment chamber.

While flooding one or more treatment chambers, a fluid level within the treatment chamber is preferably increased by a factor of at least 10, preferably at least 50, for example at least 100.

Furthermore, when one or more treatment chambers are flooded, the liquid level is preferably raised from a minimum level to at least approximately 50%, preferably at least approximately 70%, for example at least approximately 90%, of a total interior space height of the treatment chamber.

To empty one or more treatment chambers, the fluid contained therein—in particular, the treatment fluid—is preferably removed from the treatment chamber by at least approximately 50%—in particular, at least approximately 80%—for example, at least approximately 90%.

A flooding process and an emptying process are preferably performed for each workpiece or each group of workpieces which is or are introduced separately into the treatment chamber.

In one embodiment of examples disclosed herein, it is provided that the treatment system comprises a plurality of first treatment stations for carrying out a first step and a plurality of second treatment stations for carrying out a second treatment step, wherein, in each case, one or more first treatment stations and one or more second treatment stations are preferably part of a treatment unit of the treatment system or form it, through which the workpieces pass in order to perform the treatment steps.

A treatment unit comprises in particular a plurality of treatment stations which follow one another along a main conveying direction of a conveying device for conveying the workpieces. All treatment steps that can be successively performed for the workpiece treatment can preferably be performed by means of a treatment unit.

It can be provided that the treatment system comprises a plurality of treatment units which in particular each comprise one or more first treatment stations and one or more second treatment stations, and/or which in particular form different treatment lines of the treatment system.

One or more first treatment stations of treatment units that differ from each other preferably have a common fluid guide and/or a common fluid tank. Alternatively or additionally, it can be provided that one or more second treatment stations of different treatment units have a common fluid guide and/or a common fluid tank.

Furthermore, alternatively or additionally, it can be provided that one or more first treatment stations of treatment units different from each other have a common counter tank and/or a common cleaning device. In addition, alternatively or additionally, it can be provided that one or more second treatment stations of treatment units different from each other have a common counter tank and/or a common cleaning device.

It can be advantageous if a fluid, in particular a first treatment fluid, first, by means of the fluid guide,
a) can be supplied to one or more treatment chambers of one or more treatment stations, in particular first treatment stations, of a first treatment unit, and then
b) can be supplied to one or more treatment chambers of one or more treatment stations, in particular first treatment stations, of a second treatment unit. One or more intermediate storage tanks can be arranged between the first treatment unit and the second treatment unit and/or between two treatment stations of the same treatment unit or of treatment units different from each other.

It can be advantageous if a fluid, in particular a second treatment fluid, first, by means of the fluid guide,
a) can be supplied to one or more treatment chambers of one or more treatment stations, in particular second treatment stations, of a first treatment unit, and then
b) can be supplied to one or more treatment chambers of one or more treatment stations, in particular second treatment stations, of a second treatment unit. One or more intermediate storage tanks can be arranged between the first treatment unit and the second treatment unit and/or between two treatment stations of the same treatment unit or of treatment units different from each other.

It can be advantageous if the fluid can be supplied alternately to treatment chambers of treatment units different from each other by means of the fluid guide.

Alternatively or additionally, it can be provided that the fluid can be supplied alternately to treatment chambers of the same treatment unit by means of the fluid guide.

The fluid guide is preferably connected to a cleaning device or comprises such a cleaning device so that the fluid can in particular be cleaned after removal from one of the treatment chambers and/or before a new feeding to a further one of the treatment chambers.

The fluid is preferably cleaned during the emptying of a treatment chamber and/or after a single or multiple use of the same in a flooding process and/or treatment step.

A total quantity of an overall fluid contained in a fluid guide is preferably at most approximately twice, in particular at most approximately three times, a quantity of the fluid required for performing a single flooding process in a treatment chamber.

The fluid guide preferably comprises all components guiding and receiving the fluid, in particular one or more fluid tanks, one or more treatment chambers, one or more intermediate storage tanks and/or one or more counter tanks, and optionally one or more cleaning devices.

The quantity of the fluid is in particular a mass of the fluid and/or a volume of the fluid, in particular under normal conditions.

For performing cleaning tasks, the fluid can preferably be brought, in particular pumped, preferably selectively into individual or a plurality of components of the fluid guide and stored therein. For example, it can be provided that the fluid can be received completely in one or more treatment containers and/or in one or more counter tanks for cleaning at least one fluid tank. Furthermore, for example, for cleaning the one or more treatment containers, it can be provided that the fluid can be received completely in one or more fluid tanks and/or in one or more counter tanks. In addition, it can optionally be provided that, for example, for cleaning the one or more counter tanks, the fluid can be received completely in one or more fluid tanks and/or in one or more treatment containers.

It can be advantageous if a plurality, in particular all, treatment stations of a treatment unit, in particular one or more or all of the first treatment stations and one or more or all of the second treatment stations of a treatment unit, are arranged on a common plane of the treatment system. This is to be understood in particular as meaning that the treatment chambers of the treatment stations are accessible by the workpieces exclusively through a horizontal movement of the workpieces, in particular without a level change.

It can be advantageous if a plurality of treatment units of the treatment system is arranged on different planes of the treatment system.

One or more treatment stations of different treatment units of the treatment system, which have a common fluid guide and/or which serve to perform the same treatment step, are preferably arranged one above the other along the direction of gravity.

The plurality of treatment units arranged on different planes of the treatment system are preferably functionally identical, so that the same treatment steps can be performed in particular with each treatment unit in order ultimately to be able to provide a greater treatment capacity of the treatment system compared to a single treatment unit.

The workpieces are preferably each individually assigned to a single one of the plurality of treatment units and only pass through this single treatment unit. On the other hand, one or more fluid guides are preferably designed to span treatment units and in particular are assigned to a plurality of treatment units for performing the same treatment steps.

It can be advantageous if treatment stations arranged one above the other along the direction of gravity are connected by means of a common fluid guide so that, in particular, a fluid can be supplied in succession to the individual treatment stations and can be used for performing flooding processes, wherein the fluid can be guided from a treatment station to a further treatment station located therebelow along the direction of gravity in particular by using gravity.

It can be favorable if a common counter tank is arranged under all treatment stations and/or if a common fluid tank is arranged above all treatment stations.

The fluid can then, in particular, be guided from the fluid tank to an upper treatment station, then to a lower treatment station (possibly to a middle treatment station between them) and finally to the counter tank. The fluid can preferably be pumped from the counter tank back into the fluid tank by means of a pump device.

It can be advantageous if the treatment system comprises a plurality of fluid guides for guiding treatment fluids different from one another, wherein the fluid guides are assigned to treatment stations different from one another for performing different treatment steps.

Alternatively or additionally, it can be provided that the treatment system comprises a plurality of fluid guides for guiding different treatment fluids, wherein the fluid guides are assigned to the same treatment stations so that one of the treatment fluids can selectively be supplied in each case to one of the treatment stations in order to selectively perform different treatment steps.

By means of a fluid guide, the fluid is preferably guided from the fluid tank into the particular treatment chamber in order to flood one or more treatment chambers and/or from the particular treatment chamber into the fluid tank in order to empty the treatment chambers.

It can be advantageous if the fluid is removed in succession from the fluid tank, in particular completely staggered in time, and supplied to one or more treatment chambers. In particular afterwards, for example subsequently or at a later point in time, the fluid is preferably guided back into the fluid tank, optionally after a cleaning of the fluid in a cleaning device. The fluid tank and/or the one or more treatment chambers are thus preferably alternately filled and emptied.

Furthermore, it can be provided that the fluid is supplied in succession, in particular completely staggered in time, to one or more treatment chambers in a treatment station of a first treatment unit and is then supplied, in particular subsequently or at a later point in time, for example after intermediate storage in an intermediate storage tank, to one or more treatment chambers of a treatment station of a second treatment unit.

It can be advantageous if a treatment system comprises a plurality of treatment stations for treating the workpieces, in particular for cleaning and/or coating vehicle bodies, wherein one or more treatment stations preferably each comprise at least one treatment container which surrounds a treatment chamber for receiving the workpieces.

In one embodiment of examples disclosed herein, it is provided that the treatment system for treating workpieces, in particular for cleaning and/or coating vehicle bodies, comprises the following:
a) a plurality of treatment stations which each comprise a treatment container which surrounds a treatment chamber for receiving the workpieces;
b) one or more fluid tanks for receiving a fluid; and
c) a fluid guide, by means of which the fluid i) can be guided from the one or more fluid tanks into the at least one treatment chamber in order to flood at least one of the treatment chambers and/or ii) can be guided from the at least one treatment chamber into the one or more fluid tanks in order to empty the at least one treatment chamber.

It can be advantageous if a plurality of the treatment stations are arranged at height levels different from each other, wherein the treatment chambers of these treatment stations are coupled or can be coupled to one another by means of the fluid guide in such a way that the fluid can be guided from one treatment chamber into the next, in particular directly or indirectly via an intermediate storage tank arranged between them in terms of flow and/or with regard to the vertical arrangement of the fluid tanks.

The treatment system preferably has a plurality of treatment levels arranged one above the other in the vertical direction, wherein a plurality of treatment stations is preferably arranged in each case on one or more of the treatment levels. The treatment chambers of the treatment stations arranged together on one of the treatment levels are preferably connected by means of the fluid guide to one another and/or to a treatment chamber or a plurality of treatment chambers of one or more of those treatment stations which are arranged on one or more other treatment levels.

In this description and the accompanying claims, a treatment level is in particular a height position in the vertical direction in which, for example, the workpieces are supplied to the treatment chamber, or in which the workpieces are subjected to a treatment process.

It can be advantageous if the treatment system comprises two or more than two treatment stations arranged on a common treatment level, the treatment chambers of which are connected to one another by means of the fluid guide, wherein the treatment system further preferably comprises a control device which is designed and configured such that a partial filling process of one of the treatment chambers can be performed by means of the fluid guide connecting the treatment chambers to one another, in that fluid can be guided from one of the treatment chambers into a further one of the treatment chambers exclusively by using gravity.

A fluid connection of the two treatment chambers is provided in particular below half the filling height required for the flooding process, for example in a particular bottom region of the treatment chambers.

The fluid connection is based in particular on the principle of the tubes communicating with one another, according to which the fluid flows automatically from one of the treatment chambers into the other of the treatment chambers until the same fill level (water level) is reached in both treatment chambers.

When at least approximately structurally identical fluid tanks are at an identical height level, in particular approximately half of the fluid contained in a fluid tank can thus be supplied to the other fluid tank.

The rest of the first fluid tank can be emptied in particular under the influence of gravity into a fluid tank which is lower in the vertical direction, while the rest of the further fluid tank can be flooded by supplying fluid from a fluid tank which is higher in the vertical direction.

For example, a cascade guide can be provided in the vertical and horizontal direction within the fluid circuit.

In particular, it can be provided that two, for example structurally identical, treatment stations, in particular structurally identical fluid tanks, are provided in each case on an upper and a lower plane (higher and lower treatment level) within a fluid circuit, which treatment stations are in particular flooded alternately. An additional intermediate storage tank can preferably be provided between these two planes. During each flooding/emptying process, a treatment chamber to be flooded can then be flooded to 50% from the treatment chamber on the same plane that is to be emptied. The remaining 50% of the contents to be flooded of the respective treatment chamber is then flooded or emptied, for example, from a reservoir tank or intermediate storage tank arranged thereabove, or into an intermediate storage tank or counter tank arranged therebelow.

The advantage of such a double cascade guide can in particular be a reduction of the pump volume flow and thus of the energy required, since only 50% of the required fluid quantity must be pumped upwards for each flooding process taking place on the upper plane. Preferably, for the flood processes in the lower plane, no further pumping energy is required.

It can be provided that all fluid tanks which can be supplied with a fluid in succession for performing treatment processes are arranged one above the other in the vertical direction or at least at different height levels.

Furthermore, it can be provided that two or more fluid tanks are arranged adjacent to one another in the horizontal direction.

At least a portion of a fluid is preferably first guided from a fluid tank higher in the vertical direction into a fluid tank lower in the vertical direction, then into a further fluid tank arranged in a lower fluid tank in the horizontal direction and finally into a fluid tank lying therebelow.

In particular, an alternating vertical and horizontal guidance of the fluid can be provided by means of the fluid guide.

It can be advantageous if the fluid guide comprises a reservoir tank and/or an intermediate storage tank from which fluid can selectively be supplied to one of a plurality of treatment stations arranged below the reservoir tank or below the intermediate storage tank.

In this case, it can in particular be provided that a treatment chamber is selected for a flooding process and another treatment chamber is bypassed.

It can be advantageous if the treatment system comprises a pressure equalization device, by means of which a plurality of fluid tanks and/or a plurality of treatment containers are fluidically connected to one another, in particular to achieve pressure equalization at varying liquid fill levels.

All fluid tanks and all treatment containers are particularly preferably fluidically connected to one another.

In particular in the case of continuously changing fill levels in the treatment chambers, pressure fluctuations result. It can therefore be provided that all fluid tanks in the fluid circuit, in particular liquid circuit, have a pressure equalization opening, in particular a ventilation opening, through which gas, in particular air, can flow in or out. In order to avoid heat losses and to avoid a discharge of vapors of the fluid, in particular of the treatment medium, it can be desirable for only the smallest possible gas exchange between the fluid tanks and the surroundings to take place. In order to achieve this, the ventilation openings of the fluid tanks are preferably connected to one another by pipes or channels.

As a result, air displaced during the filling of a fluid tank can escape into another fluid tank, for example into the one from which the fluid is removed for the filling process. A gas exchange with the surroundings is thereby unnecessary.

The gas balance, in particular air balance, thus preferably also forms a closed system. In order to keep the system closed even for the duration of the opening of a gate of a treatment station, the pressure equalization opening associated with this treatment station, in particular the ventilation opening, can be provided with a flap or a valve, in particular for closing the ventilation opening for the duration of the gate opening. As a result, it can preferably be ensured that the exchange of air between the other fluid tanks takes place exclusively within the system and not through the open treatment station.

Despite the aim of allowing the gas exchange between the fluid tanks to take place exclusively within the system, it can be expedient, due to safety aspects, for a pipe or channel system connecting the pressure equalization openings to also be equipped with an opening to the surroundings. These pressure equalization openings can preferably be connected to the enclosure of the conveyor system in which the workpieces are transported to the treatment stations.

It can be advantageous if the pressure equalization openings, in particular the ventilation openings, and/or one or more pressure equalization lines of the pressure equalization device are arranged, designed and/or dimensioned such that they can simultaneously serve as an overflow for the fluid tanks positioned in upper planes into the counter tank. For this purpose, the pressure equalization openings, in particular the ventilation openings, are preferably to be positioned in the region of a maximum filling height, in particular in a ceiling region of the fluid tanks.

It can be advantageous if the one or more pressure equalization lines are dimensioned and/or designed such that fluid, in particular liquid, can flow downwards and gas can flow upwards simultaneously. Pressure equalization would thus also be possible in the event of an overflow.

The fluid guide preferably comprises one or more bypass lines by means of which fluid can be guided downward in the vertical direction past one or more fluid tanks and/or can be refilled into one or more fluid tanks that are lower in the vertical direction.

In this description and the accompanying claims, the reference to the vertical direction preferably merely serves to reference different height positions. An arrangement or movement in the vertical direction does not necessarily have to run vertically itself, but merely has to have a vertical component.

In particular when treatment stations are arranged at different height levels and are connected to one another by means of a common fluid guide, it can be provided that the treatment system comprises one or more bypass lines by means of which, alternatively to supplying the fluid to the successive fluid tanks, individual or a plurality of fluid tanks can be skipped without supplying fluid.

It can be advantageous if fluid from a lowermost fluid tank designed as a counter tank can be supplied directly to an intermediate storage tank by means of the return device, in particular without a detour via a highest fluid tank designed as a reservoir tank. As a result, treatment stations arranged in particular between the intermediate storage tank and the counter tank can continue to be used even if treatment stations arranged above are out of operation, for example due to maintenance work.

As an alternative or in addition thereto, it can also be provided that fluid from a fluid tank designed as an intermediate storage tank can be supplied directly to a fluid tank designed as a counter tank by means of a bypass line, in particular without passing the fluid through a fluid tank of a treatment station. The fluid can preferably also be supplied from the counter tank directly to a highest fluid tank designed as a reservoir tank. As a result, treatment stations arranged in particular between the intermediate storage tank and the reservoir tank can continue to be used even if the treatment stations arranged below are out of operation, for example due to maintenance work.

In one embodiment of examples disclosed herein, it can be provided that the treatment system comprises an intermediate storage tank arranged in the vertical direction between two or more than two treatment stations, and that the fluid guide comprises a return line, by means of which fluid can be supplied to this intermediate storage tank from a fluid tank arranged in the vertical direction below the intermediate storage tank.

Preferably, one or more reservoir tanks and/or one or more intermediate storage tanks can always each be supplied at least approximately with that fluid quantity which is required in a next step for performing a treatment process. The supply takes place in particular directly from a counter tank and/or directly into the one or more reservoir tanks and/or the one or more intermediate storage tanks.

It can be advantageous if the treatment system comprises a return device for returning fluid from a fluid tank lowermost in the vertical direction, in particular a counter tank, into a fluid tank which is higher in the vertical direction, in particular an intermediate storage tank, or into a fluid tank, for example a reservoir tank which is uppermost in the vertical direction.

It can be provided that the return device comprises a pump device, by means of which a return process can be performed in such a way, or which can be controlled by means of a control device of the treatment system in such a way, that the fluid is returned at least approximately continuously and/or with an at least approximately constant fluid volume flow and/or fluid mass flow, wherein the fluid volume flow and/or fluid mass flow generated by means of the pump device is preferably at most approximately one tenth, in particular at most approximately one fiftieth, of a fluid volume flow and/or fluid mass flow of the fluid when a treatment chamber of a treatment station is filled.

One or more supply lines for supplying fluid from a fluid tank which is higher in the vertical direction into a fluid tank which is lower in the vertical direction are preferably provided with an energy recovery device, in particular a turbine.

In particular, an energy recovery device can be arranged upstream from a fluid tank serving as a counter tank.

It can be advantageous if one or more energy recovery devices are arranged in or on one or more supply lines designed as a downpipe.

It can be advantageous if a valve device, in particular one or more valve flaps, is arranged downstream from the energy recovery device, in particular is arranged in the same supply line. As a result, it can preferably be ensured that the portion of the energy recovery device coming into contact with fluid, in particular the turbines, are continually covered or filled with fluid.

In one embodiment of examples disclosed herein, it is provided that one or more fluid tanks are sealable or sealed in a fluid-tight manner in such a way that a negative pressure is generated or can be generated in the one or more fluid tanks by emptying the same by fluid, in particular liquid, flowing out, and can be used at a later point in time in particular to simplify filling the fluid tank or the fluid tanks.

Such a fluid-tight seal can take place in particular when an intermediate storage tank is filled with fluid, and a fluid tank designed as a counter tank is at least largely empty. By emptying the intermediate storage tank, a negative pressure can be generated in it, while the inflowing fluid generates an overpressure in the counter tank. These pressure ratios can then be used to increase the pump power or pump efficiency when the fluid is conveyed from the counter tank back into the intermediate storage tank and/or into a reservoir tank by means of the return device.

In a further embodiment of examples disclosed herein, it is provided that a fluid processing circuit for processing the fluid of the lowermost fluid tank is provided on a fluid tank which is lowermost in the vertical direction, which fluid processing circuit comprises at least one pump device, at least one heat exchanger and at least one cleaning device.

Preferably, the heat exchanger is provided for controlling the temperature of the fluid and is arranged downstream from the pump device of the fluid processing circuit, and furthermore the cleaning device is preferably arranged downstream from the heat exchanger.

By means of the fluid processing circuit, the fluid is processed, preferably continuously, in the fluid tank which is lowermost in the vertical direction, in particular in the counter tank, so that the fluid which is returned to the fluid tanks which are higher in the vertical direction, in particular the reservoir tanks and intermediate tanks, by the return device is at least partially processed, i.e., is in particular at least partially cleaned.

Examples disclosed herein are also based on the object of providing a method for treating workpieces which can be performed easily and efficiently.

According to examples disclosed herein, this object is achieved by a method according to the independent method claim.

The method according to examples disclosed herein preferably comprises one or more of the features and/or advantages described in connection with the treatment system. Furthermore, the treatment system preferably comprises one or more of the features and/or advantages described in connection with the method.

It may be favorable if the method comprises the following:

Guiding fluid i) from one or more fluid tanks into the at least one treatment chamber in order to flood at least one treatment chamber and/or ii) from the at least one treatment chamber into the one or more fluid tanks in order to empty the at least one treatment chamber.

It can be advantageous if the fluid for preparing a flooding process is supplied to a fluid tank arranged above the treatment chamber at least approximately in a quantity which is required to perform the flooding process.

In particular, less than 120%, preferably less than 110%, of the quantity required to perform the flooding process is supplied.

In one embodiment of examples disclosed herein, it can be provided that the fluid, by means of a return device, is selectively:
a) supplied to a reservoir tank in order to fill it with fluid and to provide the fluid for a flooding process in a treatment station arranged below the reservoir tank; or
b) guided in a circuit past the treatment station by means of a bypass line.

In a particularly advantageous embodiment of examples disclosed herein, it can be provided that a reservoir tank, which in particular forms a fluid tank that is highest in the vertical direction, is continuously filled with fluid, in particular treatment fluid, preferably treatment liquid. A pump device thus preferably conveys the fluid continuously into the reservoir tank.

By means of one or more valve devices, a fluid connection between two or more than two fluid tanks is preferably established so that the fluid, in particular via one or more supply lines designed as downpipes, can flow into one or more fluid tanks underneath.

By means of a control device, the opening of the one or more valve devices is preferably controlled and/or regulated in such a way that a predefined fill level is at least approximately reached in the one or more fluid tanks underneath. A control and/or regulation can take place on the basis of a measurement or other determination of the fill level in the reservoir tank and/or in the intermediate storage tank and/or in the respective fluid tank.

Depending on a fill level in the intermediate storage tank or reservoir tank at the beginning of the flooding process, a residual fill level can remain therein after the flooding process, or the intermediate storage tank or reservoir tank can run empty during the flooding process so that, until the desired fill level required for performing a treatment process is reached in the fluid tank underneath, fluid conveyed by the pump device into the intermediate storage tank or reservoir tank runs unhindered through the intermediate storage tank or reservoir tank into the fluid tank, in particular into the treatment chamber, underneath.

Alternatively, it can be provided that, before each flooding process, the uppermost fluid tank, in particular the reservoir tank, is filled with the aid of the pump device with precisely the fluid quantity which is required for one-time flooding of the treatment chamber in the fluid tank underneath. In this case, the valve device is opened for the flooding process until the fluid tank, in particular the reservoir tank, is completely emptied into the fluid tank underneath. In this way, the desired fill level can be adjusted more easily since a fill level measurement does not have to be used during the highly dynamic flooding process. The risk of overfilling is thereby minimized.

Optionally, it can thereby be provided that the pumping process into the counter tank is interrupted at least for the duration of the flooding process, whereby an increased conveyed volume flow can temporarily be required. In this case, a bypass is preferably provided in the pump circuit in order to move the medium in a circuit during the interruption of the conveying process instead of subjecting the pump to increased wear by from switch-on and switch-off processes.

Further preferred features and/or advantages of examples disclosed herein form the subject matter of the following description and the drawings illustrating exemplary embodiments.

### BRIEF DESCRIPTION OF THE DRAWINGS

FIG. 1 shows a schematic view of a first embodiment of a treatment system in which a reservoir tank, a treatment station, an intermediate storage tank, a further treatment station, and a counter tank are arranged one above the other;

FIG. 2 shows a schematic view, corresponding to FIG. 1, of a second embodiment of a treatment system in which two treatment stations are arranged at each of two treatment levels;

FIG. 3 shows a schematic view, corresponding to FIG. 1, of a third embodiment of a treatment system in which a bypass line for bypassing at least one treatment station is provided on a treatment level;

FIG. 4 shows a schematic view, corresponding to FIG. 1, of a fourth embodiment of a treatment system in which a plurality of bypass lines for bypassing a plurality of treatment stations are provided on a plurality of treatment levels; and

FIG. 5 shows a schematic view, corresponding to FIG. 1, of a fifth embodiment of a treatment system in which a fluid processing circuit is provided on the counter tank.

The same or functionally equivalent elements are provided with the same reference signs in all figures.

### DETAILED DESCRIPTION OF THE DRAWINGS

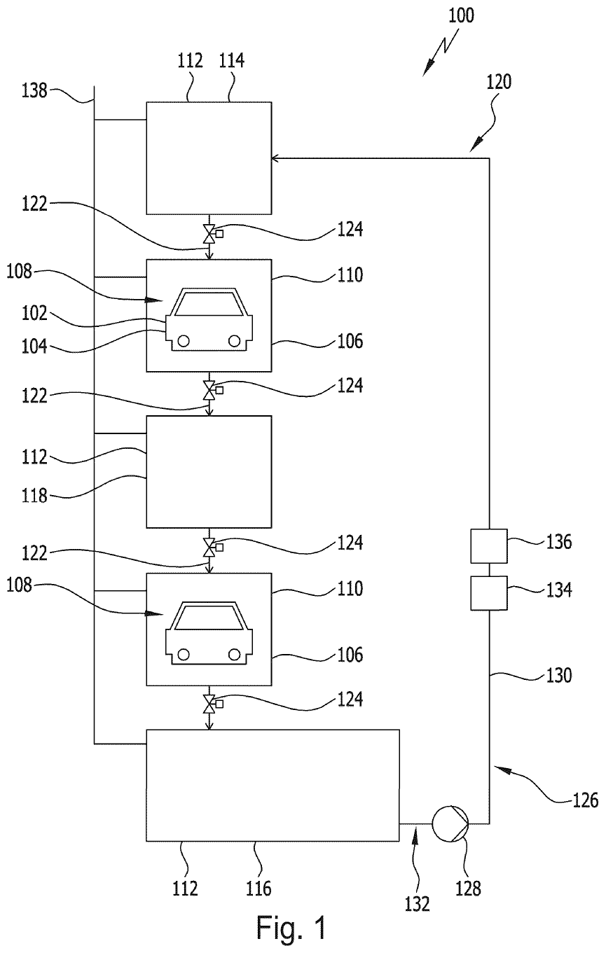

An embodiment of a treatment system shown in FIG. 1 and denoted as a whole by “100” serves to treat workpieces 102, in particular vehicle bodies 104.

The treatment system 100 is, for example, a coating system, pretreatment system and/or painting system which is used in the production of motor vehicles, in particular passenger cars.

The treatment system 100 comprises a plurality of treatment stations 106 at which treatment steps, in particular pretreatment steps, coating steps, and/or painting steps, can be performed.

The treatment stations 106 each comprise a treatment chamber 108 which is surrounded by a treatment container 110. The treatment container 110 is in particular formed by a fluid tank 112 which can be filled with fluid.

The fluid is in particular a treatment fluid, for example a treatment liquid.

Furthermore, the treatment system 100 comprises a plurality of further fluid tanks 112 which serve to receive and/or provide the fluid when this is not arranged in one or more of the fluid tanks 112 forming the treatment containers 110.

The further fluid tanks 112 form, in particular, a reservoir tank 114 which is arranged in particular in the vertical direction at the uppermost position, a counter tank 116 which is arranged in particular in the vertical direction at the lowermost position, and an intermediate storage tank 118 which is arranged in particular between the two fluid tanks 112 forming the treatment containers 110.

The treatment system 100 also comprises a fluid guide 120, by means of which the fluid tanks 112 are fluidically connected or connectable to one another in order to be able to guide the fluid from one fluid tank 112 to the next.

In particular, fluid can be supplied to the treatment chambers 108 by means of the fluid guide 120, and the fluid can be discharged therefrom after treatment has taken place.

The fluid guide 120 comprises a plurality of supply lines 122, by means of which fluid can be guided in particular from a fluid tank 112 which is higher in the vertical direction into a fluid tank 112 which is lower in the vertical direction. In so doing, pumps or other drives are unnecessary. The fluid is supplied via the supply lines 122 preferably exclusively by utilizing gravity.

Valve devices 124 are preferably arranged in the supply lines 122 in order to be able to adjust, control and/or regulate the quantity of fluid to be supplied, and/or a fluid volume flow, and/or a fluid mass flow. A control device (not shown) of the treatment system 100 can be provided in particular for controlling and/or regulating.

The fluid guide 120 also comprises a return device 126, by means of which fluid can be guided, in particular conveyed, counter to the direction of gravity from a fluid tank 112 which is lower in the vertical direction into a fluid tank 112 which is higher in the vertical direction. For this purpose, the return device 126 comprises in particular a pump device 128 and a return line 130 which connects the counter tank 116 directly to the reservoir tank 114.

The supply lines 122 and the return line 130 form, in particular together with the fluid tanks 112, a self-contained fluid circuit 132 for recurring use of the fluid in the treatment chambers 108.

In order to process and/or clean the fluid, the treatment system 100 preferably comprises a cleaning device 134 by means of which impurities can in particular be removed from the fluid, and/or by means of which a chemical composition of the fluid can be adjusted to ensure an optimized and/or uniform treatment result.

The cleaning device 134 is arranged, for example, in the return line 130 or connected thereto, so that the cleaning or other processing of the fluid can take place in particular during the return of the fluid from the counter tank 116 into the reservoir tank 114.

Furthermore, the treatment system 100 optionally comprises a heat exchanger 136 for controlling the temperature of the fluid. The heat exchanger 136 can be coupled to any heat sources or heat sinks in order to heat or cool the fluid as required. The heat exchanger 136 is also arranged, for example, in the return line 130 or connected thereto so that the temperature of the fluid can be controlled in particular during the return of the fluid from the counter tank 116 into the reservoir tank 114.

As can be seen from FIG. 1, the treatment system 100 further comprises a pressure equalization device 138 which fluidically connects the fluid tanks 112 to one another and/or to the surroundings of the treatment system 100. The pressure equalization device 138 thereby allows gas to be exchanged between the fluid tanks 112, while the fluid guide 120 allows a fluid exchange.

Pressure fluctuations occurring in the fluid tanks 112 in particular during filling and emptying of the fluid tanks 112 can be equalized by the pressure equalization device 138.

Any vapors escaping from the fluid or other gaseous impurities arising in the fluid tanks 112 can preferably be discharged in an environmentally friendly manner, in particular thermally processed and disposed of, by the pressure equalization device 138.

The embodiment of the treatment system 100 shown in FIG. 1 functions as follows:

First, the fluid is provided in the reservoir tank 114 and a workpiece is introduced into the fluid tank 112 located below it, which forms an upper treatment chamber 108. The fluid tank 112 is then closed in order to allow flooding thereof and to avoid undesired escape of the fluid into the surroundings. The workpiece 102 is thereby completely or at least partially surrounded by the fluid, wherein a chemical or physical treatment, for example a cleaning or coating step, is performed.

After this treatment, the fluid is drained from the fluid tank 112 which forms the upper treatment chamber 108. The fluid thereby passes into the intermediate storage tank 118 and is thus provided for reuse thereof in the fluid tank 112 forming a lower treatment chamber 108.

As soon as a workpiece 102 has been introduced into this lower treatment chamber 108 and the treatment chamber 108 has been closed, the fluid is supplied from the intermediate storage tank 118, and the workpiece treatment is performed. This workpiece treatment preferably corresponds to the workpiece treatment performed in the upper treatment chamber 108.

Subsequently, the fluid is drained from the lower treatment chamber 108 and thereby passes into the counter tank 116.

By means of the return device 126, the fluid can finally be resupplied to the reservoir tank 114, in particular after it is cleaned by means of the cleaning device 134 and/or its temperature is controlled by means of the heat exchanger 136.

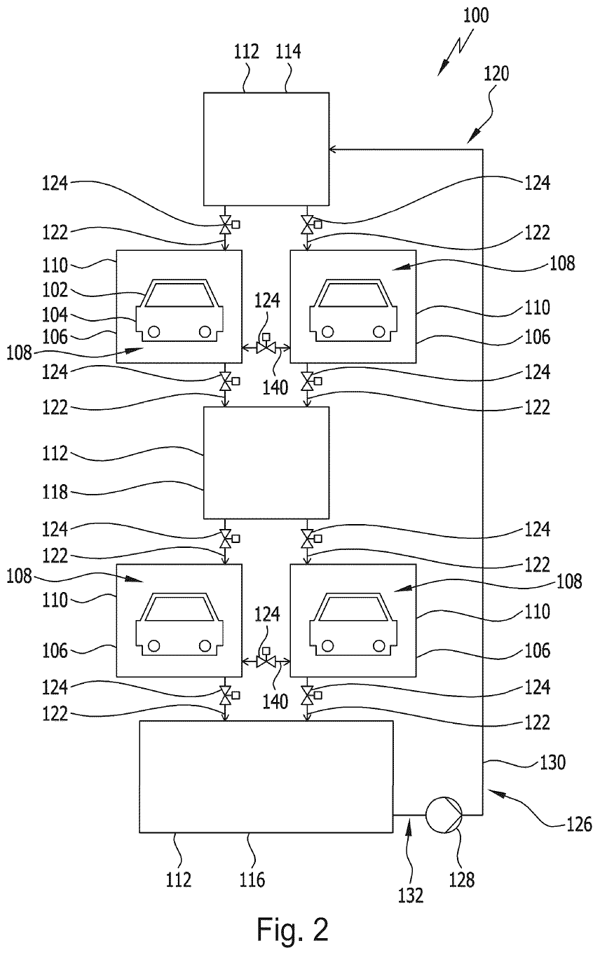

A second embodiment of a treatment system 100 shown in FIG. 2 differs from the first embodiment shown in FIG. 1 substantially in that two treatment chambers 108 are provided at the same height level, i.e., in the horizontal direction side by side.

The two treatment chambers 108 arranged at the same height level are each fluidically connected to one another in a bottom region thereof by means of a fluid line 140. A valve device 124 is arranged in each of the fluid lines 140 in order to selectively establish or inhibit the fluid connection.

In particular, the fluid lines 140 allow the fluid to be supplied from a treatment chamber 108 to a further treatment chamber 108 arranged at the same height level. For this purpose, first only one of the treatment chambers 108 is filled with fluid from a fluid tank 112 above it, while the further treatment chamber 108 remains empty. After workpiece treatment has taken place in the initially filled treatment chamber 108, the valve device 124 can be opened in the fluid line 140 so that the fluid flows into the further treatment chamber 108 and fills it.

Since the two treatment chambers 108 are arranged at the same height level and pump devices are preferably not used at this point, opening the valve device 124 does not achieve a complete transition of the fluid into the further treatment chamber 108. Rather, the fill level in the treatment chambers 108 is simply matched.

In order to then fill the further treatment chamber 108 in a next step to a desired fill level, the valve device 124 is closed, and fluid is supplied from the fluid tank 112 above it.

The initially filled treatment chamber 108 is in particular completely emptied in parallel therewith, in that the fluid which is not flowing into the further treatment chamber 108 is drained into a fluid tank 112 underneath, in particular the intermediate storage tank 118.

In the second embodiment of the treatment system 100 shown in FIG. 2, the fluid is thus conveyed further, preferably at least partially alternately, in the horizontal and in the vertical direction.

The energy efficiency of the treatment system 100 can preferably be optimized by the partial use of the fluid at the same height level.

Otherwise, the second embodiment of the treatment system 100 shown in FIG. 2 corresponds with respect to structure and function to the first embodiment shown in FIG. 1 so that reference is made to the description thereof above.

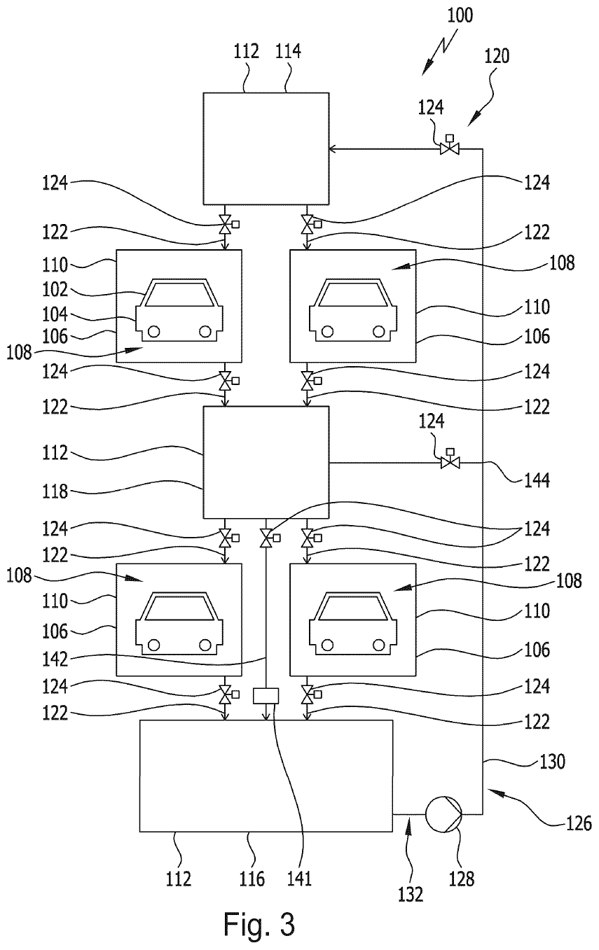

A third embodiment of a treatment system 100 shown in FIG. 3 differs from the second embodiment shown in FIG. 2 substantially in that an additional fluid line is provided which connects the intermediate storage tank 118 directly to the counter tank 116. The fluid line is a bypass line 142 which bypasses the fluid tanks 112 forming the lower treatment chambers 108.

A fluid flow from the intermediate storage tank 118 into the counter tank 116 can be controlled and/or regulated by a valve device 124 arranged in the bypass line 142.

The bypass line 142 thus allows in particular the maintenance of the fluid circuit 132 while bypassing the lower treatment chambers 108 so that the treatment system 100 can continue to be used in particular when the lower treatment chambers 108 are out of operation, for example, due to maintenance work.

Furthermore, according to the third embodiment shown in FIG. 3, the treatment system 100 comprises a branch 144 in the return line 130 so that the fluid can selectively be supplied to the reservoir tank 114 or to the intermediate storage tank 118 by means of the return device 126.

The reservoir tank 114 and the upper treatment chambers 108 located directly underneath can thus also selectively be bypassed so that only the lower treatment chambers 108 can be used if required. The upper treatment chambers 108 can thereby be accessible for maintenance purposes, for example.

Optionally, in each of the described and/or depicted embodiments, an energy recovery device 141 can also be provided, which is shown by way of example in the bypass line 142 of the treatment system 100 in FIG. 3.

The energy recovery device 141 serves to convert the potential and/or kinetic energy of the fluid into electrical energy and/or mechanical energy. The fluid flowing, for example, from the intermediate storage tank 118 can thus be used to generate mechanical and/or electrical energy. At least a portion of the energy required for the operation of the fluid guide can thereby preferably be recovered.

Otherwise, the third embodiment of the treatment system 100 shown in FIG. 3 corresponds, in terms of structure and function, to the second embodiment shown in FIG. 2 so that reference is made in this respect to the above description thereof.

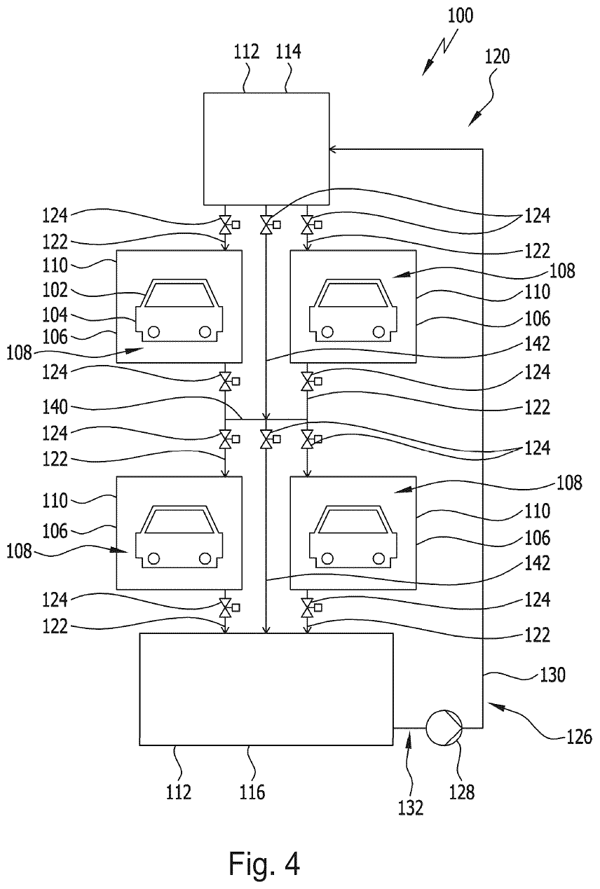

A fourth embodiment of a treatment system 100 shown in FIG. 4 differs from the third embodiment shown in FIG. 3 substantially in that no intermediate storage tank is provided.

Rather, supply lines 122, bypass lines 142 and other fluid lines 140 of the fluid guide 120 are provided, through which, starting from the reservoir tank 114, fluid can be supplied to all treatment chambers 108 directly or indirectly via a preceding treatment chamber 108.

In addition, all treatment chambers 108 can be bypassed if necessary by means of continuous bypass lines 142, which extend from the reservoir tank 114 to the counter container 116. The fluid circuit 132 can thereby also be maintained, even if in particular workpiece treatment is temporarily not performed but switching off the pump device 128 is undesirable.

Otherwise, the fourth embodiment of the treatment system 100 shown in FIG. 4 corresponds, in terms of structure and function, to the third embodiment shown in FIG. 3 so that reference is made in this respect to the above description thereof.

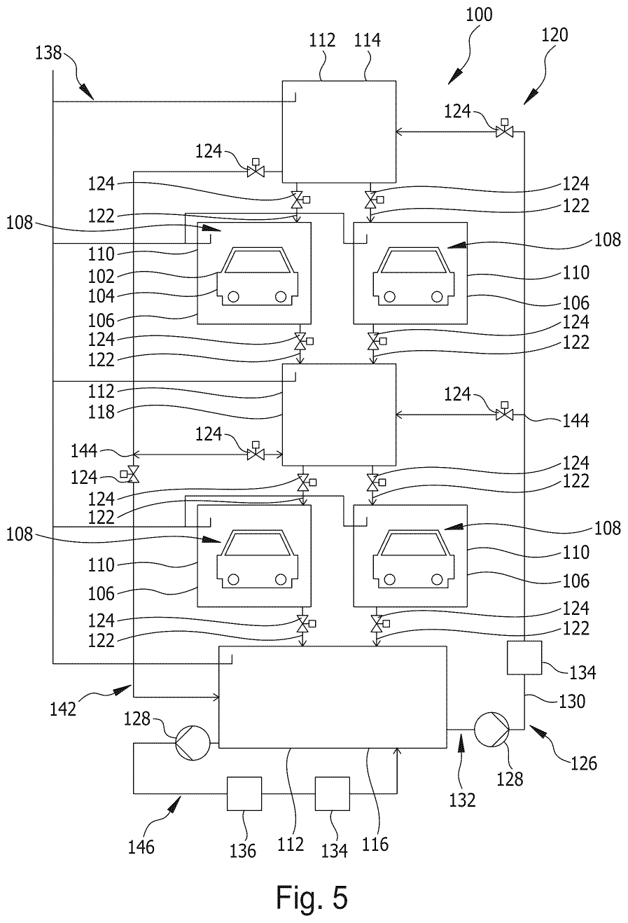

A fifth embodiment of a treatment system 100 shown in FIG. 5 substantially differs from the third and fourth embodiments shown in FIGS. 3 and 4, respectively, in that a fluid processing circuit 146 for processing the fluid of the counter tank 116 is arranged on the counter tank 116 in a maximally provided expansion stage of the fluid guide 120 of the treatment system 100, in that a bypass line 142 is provided, and in that a pressure equalization device 138 is provided which fluidically connects all fluid tanks 112 and treatment chambers 108 to one another in order to achieve pressure equalization at varying liquid fill levels.

The fluid processing circuit 146 guides fluid out of the counter tank 116 and is conveyed through the fluid processing circuit 146 by means of a pump device 128.

A heat exchanger 136, which serves to control the temperature of the fluid, is arranged downstream from the pump device 128, and a cleaning device 134, which is used to process the fluid, is arranged downstream from the heat exchanger 136.

Downstream from the cleaning device 134, the processed fluid is returned to the counter tank 116.

The fluid is preferably processed continuously during operation of the treatment system 100. As a result of the processing of the fluid, which is collected in the counter tank 116, at least partially processed fluid is guided into the return device 126 and is thereby again provided, at least partially processed, in the reservoir tank 114 and/or intermediate storage tank 118.

Furthermore, a further cleaning device 134 can be provided in the return line 130 downstream from the pump device 128 of the return device 126 and further processes the returned fluid before it is supplied to the reservoir tank 114 and/or to the intermediate storage tank 118.

The bypass line 142 connects the reservoir tank 114, the intermediate storage tank 118 and the counter tank 116 to one another.

On the one hand, the bypass line 142 makes it possible to guide fluid from the reservoir tank 114 past the intermediate storage tank 118 into the counter tank 116, for which purpose the valve device 124 located directly upstream from the intermediate storage tank 118 has to be in the closed position. For example, the reservoir tank 114 can thus be emptied into the counter tank 116.

On the other hand, it can be possible, by means of the bypass line 142, to divert fluid from the reservoir tank 114, bypassing the upper treatment containers 110, via the branch 144 into the intermediate storage tank 118, whereby more fluid is available for treating the lower treatment containers 110.

To divert the fluid from the reservoir tank 114 into the intermediate storage tank 118, the additional valve device 124, which is arranged between the reservoir tank 114 and the counter tank 116 and is arranged downstream from the branch 144, has to be in the closed position.

Furthermore, with small throughputs of workpieces 102 through the treatment system 100, for example, the treatment can be omitted on a horizontal plane, i.e., in all treatment containers 110 of a plane, and/or in one treatment container 110 per plane.

Otherwise, the fifth embodiment of the treatment system 100 shown in FIG. 5 corresponds, in terms of structure and function, to the third and fourth embodiments shown in FIGS. 3 and 4, respectively, such that reference is made in this respect to the above description thereof.

### List of Reference Signs

100 Treatment system
102 Workpiece
104 Vehicle body
106 Treatment station
108 Treatment chamber
110 Treatment container
112 Fluid tank
114 Reservoir tank
116 Counter tank
118 Intermediate storage tank
120 Fluid guide
122 Supply line
124 Valve device
126 Return device
128 Pump device
130 Return line
132 Fluid circuit
134 Cleaning device
136 Heat exchanger
138 Pressure equalization device
140 Fluid line
141 Energy recovery device
142 Bypass line
144 Branch
146 Fluid processing circuit

1. A treatment system for treating workpieces, optionally for cleaning and/or coating vehicle bodies, the treatment system comprising:
a) a plurality of treatment stations each including a treatment container which surrounds a treatment chamber for receiving the workpieces;
b) one or more fluid tanks for receiving a fluid; and
c) a fluid guide, by which the fluid i) can be guided from the one or more fluid tanks (142) into the at least one treatment chamber to flood at least one of the treatment chambers and/or ii) from the at least one treatment chamber into the one or more fluid tanks to empty the at least one treatment chamber.

2. The treatment system according to claim 1, wherein a plurality of the treatment stations are arranged at height levels different from each other, wherein the treatment chambers of these treatment stations are coupled or can be coupled to one another by the fluid guide in such a way that the fluid can be guided from one treatment chamber into the next, optionally directly or indirectly via an intermediate storage tank arranged therebetween in terms of flow and/or with regard to the vertical arrangement of the fluid tanks.

3. The treatment system according to claim 1, wherein the treatment system has a plurality of treatment levels arranged one above the other in the vertical direction, wherein a plurality of treatment stations are each arranged on one or more of the treatment levels, and wherein the treatment chambers of the treatment stations arranged together on one of the treatment levels are connected by the fluid guide to one another and/or to a treatment chamber or a plurality of treatment chambers of one or more of the treatment stations which are arranged on one or more other treatment levels.

4. The treatment system according to claim 1, wherein the treatment system includes two or more than two treatment stations arranged on a common treatment level, the treatment chambers of which are connected to one another by the fluid guide,
wherein the treatment system further includes a control device which is designed and configured such that a partial filling process of one of the treatment chambers can be performed by the fluid guide connecting the treatment chambers to one another, in that fluid can be guided from one of the treatment chambers into a further one of the treatment chambers, optionally exclusively by using gravity.

5. The treatment system according to claim 1, wherein the fluid guide includes a reservoir tank and/or an intermediate storage tank from which fluid can selectively be supplied to one of a plurality of treatment stations arranged below the reservoir tank or below the intermediate storage tank.

6. The treatment system according to claim 1, wherein the treatment system comprises includes a pressure equalization device by which a plurality of fluid tanks and/or a plurality of treatment containers, optionally all fluid tanks and all treatment containers, are fluidically connected to one another, in particular to achieve pressure equalization at varying liquid fill levels.

7. The treatment system according to claim 1, wherein the fluid guide includes one or more bypass lines by which fluid can be guided downwards in the vertical direction past one or more fluid tanks and/or can be refilled into one or more fluid tanks which are lower in the vertical direction.

8. The treatment system according to claim 1, wherein the treatment system includes an intermediate storage tank arranged in the vertical direction between two or more than two treatment stations, and in that the fluid guide includes a return line by which fluid can be supplied to this intermediate storage tank from a fluid tank arranged in the vertical direction below the intermediate storage tank.

9. The treatment system according to claim 1, wherein the treatment system includes a return device for returning fluid from a fluid tank which is lowermost in the vertical direction, optionally a counter tank, into a fluid tank which is higher in the vertical direction, optionally an intermediate storage tank, or into a fluid tank which is uppermost in the vertical direction, for example a reservoir tank.

10. The treatment system according to claim 9, wherein the return device includes a pump device, by which a return process can be performed in such a way or which can be controlled by a control device of the treatment system in such a way that the fluid is returned at least approximately continuously and/or with an at least approximately constant fluid volume flow and/or fluid mass flow, wherein the fluid volume flow and/or fluid mass flow generated by the pump device is at most approximately one tenth, in particular at most approximately one fiftieth, of a fluid volume flow and/or fluid mass flow of the fluid while filling a treatment chamber of a treatment station.

11. The treatment system according to claim 1, wherein one or more supply lines for supplying fluid from a fluid tank, which is higher in the vertical direction, into a fluid tank, which is lower in the vertical direction, are provided with an energy recovery device, optionally a turbine.

12. The treatment system according to claim 1, wherein one or more fluid tanks can be sealed or are sealed in a fluid-tight manner in such a way that a negative pressure is generated or can be generated in the one or more fluid tanks by emptying the same by fluid, optionally liquid, flowing out, and can be used at a later point in time optionally to simplify filling the fluid tank or the fluid tanks.

13. The treatment system according to claim 1, wherein a fluid processing circuit for processing the fluid of the lowermost fluid tank is provided on a fluid tank which is lowermost in the vertical direction and includes at least one pump device, at least one heat exchanger and at least one cleaning device.

14. A method for treating workpieces, optionally vehicle bodies, the method comprising:
guiding fluid i) from one or more fluid tanks into the at least one treatment chamber to flood at least one treatment chamber and/or ii) from the at least one treatment chamber into the one or more fluid tanks in order to empty the at least one treatment chamber.

15. The method according to claim 14, wherein the fluid for preparing a flooding process is supplied to a fluid tank arranged above the treatment chamber at least approximately in a quantity required to perform the flooding process.

16. The method according to claim 14, wherein the fluid, by a return device, is selectively:
a) supplied to a reservoir tank to fill the reservoir tank with fluid and provide the fluid for a flooding process in a treatment station arranged below the reservoir tank; or
b) guided in a circuit past the treatment station by a bypass line.
